(19) United States
(12) Patent Application Publication
(10) Pub. No.: US 2010/0042274 A1
(43) Pub. Date: Feb. 18, 2010

(54) ATTITUDE CONTROL METHOD USING TARGET TRACK APPROXIMATION

(75) Inventors: Seong-Kyun Jeong, Daejon (KR); Sang-Uk Lee, Daejon (KR); Jae-Hoon Kim, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 12/443,178

(22) PCT Filed: Sep. 17, 2007
(86) PCT No.: PCT/KR07/04476

§ 371 Date: Mar. 26, 2009

(30) Foreign Application Priority Data
Sep. 27, 2006 (KR) 10-2006-0094396

(51) Int. Cl. G05D 1/00

(52) U.S. Cl. 701/13

(57) ABSTRACT

Provided is a method for controlling an attitude of a satellite using target track approximation. The method includes the steps of: a) receiving coordinate information of at least one of target areas; b) generating a target track by approximating a track of a satellite based on the received coordinate information; and c) detecting a location of the satellite on a current track, calculating an attitude angle of the satellite for the target track using the location of the satellite and the location of the target area, and applying the calculated attitude angle of the satellite to control the attitude of the satellite.

### TECHNICAL FIELD

The present invention relates to a satellite attitude control method, which can be used for a satellite photographing plan or for antenna pointing; and, more particularly, to a satellite attitude control method using target track approximation for quickly detecting a target area such as a photographing area or an antenna pointing area and controlling the attitude of a satellite.

This work was supported by the Information Technology (IT) research and development program of the Korean Ministry of Information and Communication (MIC) and the Korean Institute for Information Technology Advancement (IITA) [2005-S-301-02, “Development of Satellite Communications System for Communications, Ocean and Meteorological Satellite”]

### BACKGROUND ART

The present invention relates to a technology for finding the optimal satellite attitude track and photographing track by automating satellite control technologies performed in the ground in an aerospace field.

However, the satellite control technologies may provide inaccurate information because operators in a control center often make mistakes. Due to inaccurate information, a proper track may not be generated and it makes impossible to photograph a target area, accurately. It is very important to accurately generate a target track for photographing images and for making an operating plane of a satellite corresponding to the satellite attitude and a track control.

In general, a conventional attitude control method for a satellite is for photographing a predetermined area on the ground. In case of a satellite that dynamically changes the attitude thereof for photographing the image of the predetermined area, the satellite needs to generate the complex target track. When the complex target track is generated, the satellite may change the attitude thereof abruptly. Such a sudden movement of the satellite may cause a problem to capture target images.

Also, the conventional attitude control method for a satellite requires high cost and large man power to photograph many areas, to make a long term plan of photographing images, and to photograph images with various modes.

Therefore, a satellite control system must have a capability to control the attitude thereof by effectively and quickly generating a target track although an emergency photographing operation is required. If such a function is embodied automatically, it is possible to perform various operations.

### DISCLOSURE

### Technical Problem

An embodiment of the present invention is directed to providing a satellite attitude control method using target track approximation which generate a target track of a satellite based on target ground area information given from a mission planning system and automatically calculate the attitude of a satellite based on the current location of a satellite.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for controlling an attitude of a satellite using target track approximation, including the steps of: a) receiving coordinate information of at least one of target areas; b) generating a target track by approximating a track of a satellite based on the received coordinate information; and c) detecting a location of the satellite on a current track, calculating an attitude angle of the satellite for the target track using the location of the satellite and the location of the target area, and applying the calculated attitude angle of the satellite to control the attitude of the satellite.

As described above, the present invention relates to a method for controlling the attitude of a satellite by quickly detecting a target ground area such as a photographing area and a antenna pointing area in order to effectively set various directional targets from a current track of a satellite and use the target track to control the attitude of a satellite.

As a satellite photographing technology has been advanced, a technology for photographing multiple target areas by dynamically changing the attitude of a satellite from a ground control center was introduced. Therefore, it has been recognized as an important issue to make a plan of controlling a satellite to photograph target areas by freely selecting the target areas of the ground. It was impossible to effectively set a target track using a conventional system. Therefore, there is a demand for developing the related technology thereof.

Accordingly, target areas are sampled to photograph from a satellite, and a track proper is generated to conveniently control the attitude of a satellite based on the sampled data in an embodiment of the present invention.

In the present invention, it is determined whether it is possible to quickly control the attitude of a satellite or not using the generated track, and the generated track is used to make an attitude control plan of a ground system. Such a method is very effective for making a plan of controlling the attitude of a satellite to photograph various areas and for making a satellite mission plan.

Since the plan for controlling the attitude of a satellite to photograph is very complicated, it is effective to automatically generate a photographing track.

A satellite mission analysis and plan system of a satellite control system selects target photographing areas and selects a photographing track using the method of the present invention. The attitude of a satellite is calculated using the current location of a satellite and the locations of target areas.

Therefore, the efficiency can be improved and the target track can be properly generated for making a plan for controlling the attitude of a satellite using a target track approximation method and a target directional pointing method in the present invention. Since various target tracks can be generated, various photographing missions of a satellite can be performed. Such a system can be generally used in various satellite systems. Particularly, it is prevented a satellite from being vibrated due to the abrupt attitude change of a satellite and it can be used to obtain high quality images with high sharpness.

### Advantageous Effects

A satellite attitude control method using target track approximation according to an embodiment of the present invention can quickly make a mission plan and effectively control the attitude thereof when it is required to control the attitude on a track due to a plurality of photographing areas.

Also, the satellite attitude control method according to an embodiment of the present invention prevents the satellite from being vibrated when a photographing mission is performed by preventing abrupt attitude change, and can be used for quickly and accurately controlling the satellite.

### BRIEF DESCRIPTION OF THE DRAWINGS

FIG. 1 is a diagram illustrating the photographing plan or the antenna pointing of a satellite in accordance with an embodiment of the present invention.

FIG. 2 is a block diagram of a ground control system for a satellite where the present invention is applied.

FIG. 3 is a diagram illustrating the generation of a photographing track and the antenna pointing of a satellite in accordance with an embodiment of the present invention.

FIG. 4 is a flowchart illustrating a satellite attitude control method using target track approximation in accordance with an embodiment of the present invention.

### BEST MODE FOR THE INVENTION

The advantages, features and aspects of the invention will become apparent from the following description of the embodiments with reference to the accompanying drawings, which is set forth hereinafter.

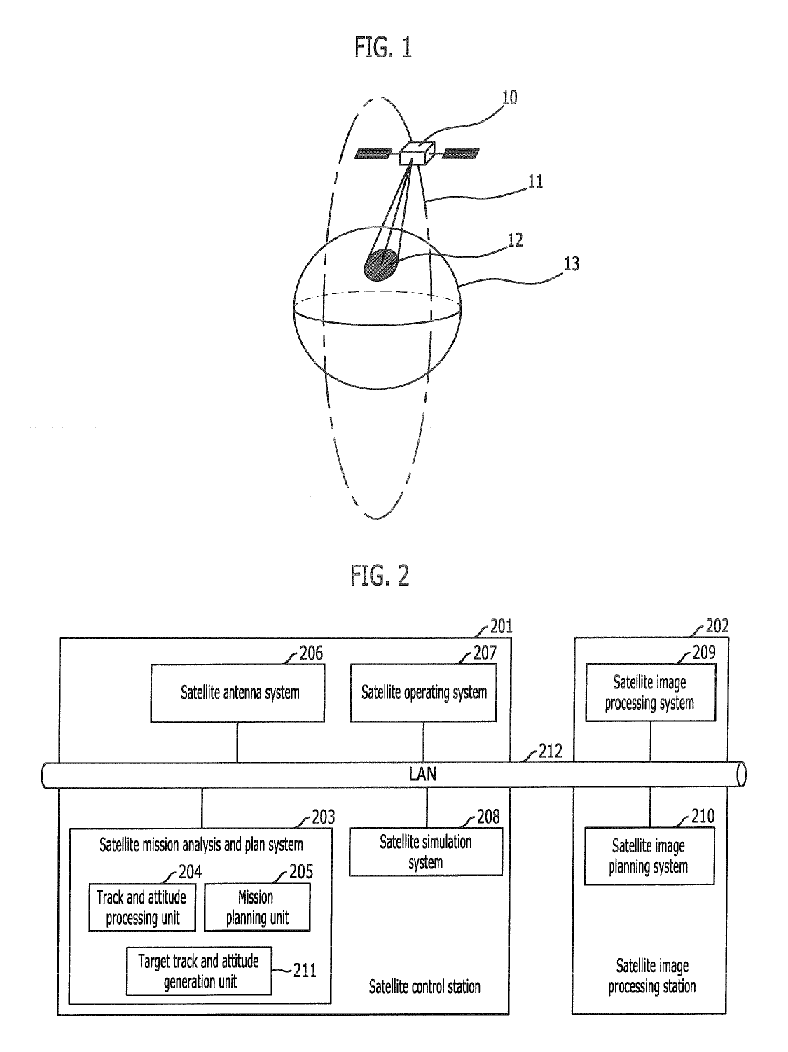

FIG. 1 is a diagram illustrating the photographing plan or the antenna pointing of a satellite in accordance with an embodiment of the present invention.

FIG. 1 shows a satellite 10 having a mission of photographing a target area 12 among various areas of the ground of the earth 13 from a current track 11.

In order to obtain the attitude angle of a satellite, information about the position of a satellite and information about a target area 12 from a current track 11 of the satellite must be given. The pointing direction of a satellite 10 is decided according to the given information.

FIG. 2 is a block diagram of a ground control system for a satellite where the present invention is applied.

As shown in FIG. 2, a ground control system for controlling a satellite to photograph the images of grounds includes a satellite control station 201 for directly controlling a satellite, and a satellite image processing station 202 for processing image data that is captured by the satellite.

The satellite control station 201 includes a mission analysis and plan system 203 for analyzing and planning a mission in order to successfully perform the mission of a satellite. The mission analysis and plan system 203 includes a track and attitude processing unit 204 for calculating a track and an attitude of a satellite and a mission planning unit 205 for planning the mission of a satellite.

Beside of that, the satellite control station 201 includes a satellite antenna system 206 for communicating with a satellite, a satellite operating system 207 for generating remote instructions through monitoring the states of a satellite, and a satellite simulation system 208 for checking an operation procedure before the satellite is actually controlled.

The satellite image processing station 202 includes a satellite image processing system 209 for processing image data and a satellite image planning system 210 for planning a photographing plan.

Meanwhile, a target track and attitude generation unit 211 performs a satellite attitude control method for making a satellite photographing plan or for antenna pointing according to an embodiment of the present invention. The satellite mission analysis and plan system 203 employs the satellite attitude control method to calculate a tracking direction of a satellite. That is, the satellite image planning system 210 makes a photographing plan, and the target track and attitude generation unit 211 calculates a tracking direction based on the photographing plan from the satellite photographing planning system 210.

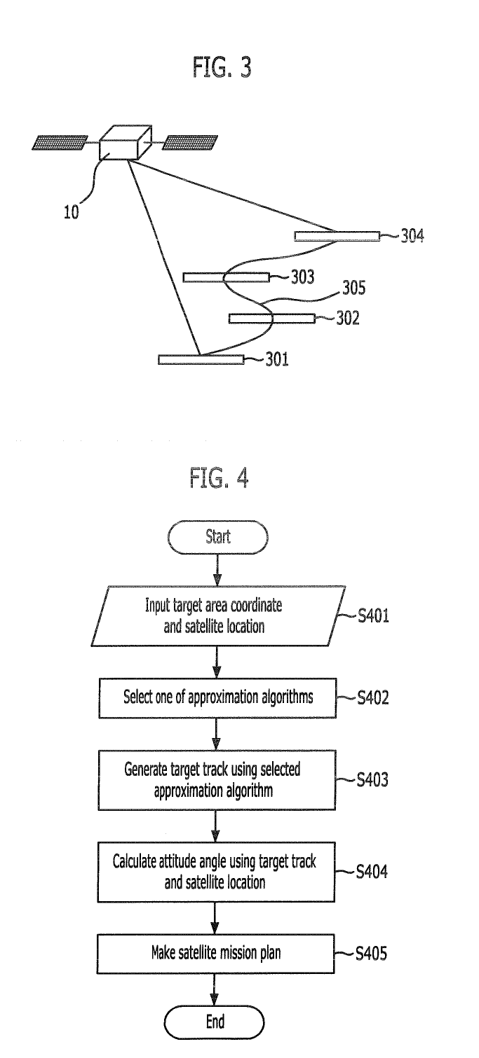

FIG. 3 is a diagram illustrating the generation of a photographing track and an antenna pointing of a satellite in accordance with an embodiment of the present invention.

As shown in FIG. 3, the satellite control station 201 receives information about a first ground photographing area 301, a second ground photographing area 302, a third ground photographing area 303, and a fourth ground photographing area 304. Then, the satellite control station 201 approximates a satellite track to photography the target areas based on the information of the photographing areas. The approximated track 205 is generated to include all of the photographing areas. Then, a location of a satellite on a track is detected after the track approximation, and the attitude of a satellite is controlled by calculating an attitude angle of a satellite.

FIG. 4 is a flowchart illustrating a satellite attitude control method using target track approximation in accordance with an embodiment of the present invention.

As shown in FIG. 4, the coordinate information of a target area and the location of a satellite are received for controlling an attitude of a satellite at step S401.

Then, the photographing track of a satellite is approximated at step S402 and a target track is generated at step S403. For example, an approximation algorithm is selected to approximate a satellite photographing track. The approximation algorithm will be described in later.

Then, the location of a satellite is detected from a current track, and the attitude angle of a satellite for the target track is calculated using the current location of a satellite and the target area at step S404. Based on the calculated attitude angle of the satellite, a mission plan of the satellite is made at step S405 in order to apply the mission plan to the satellite attitude control.

Hereinafter, the satellite attitude control method using target track approximation according to an embodiment of the present invention will be described in more detail.

At first, the coordinate of a target photographing area and the current location of a satellite are received when the calculation of an attitude angle starts. By receiving the coordinates of photographing areas, it is checked points where a photographing track must pass through.

Then, a track is approximated based on the received target coordinates and an approximated track passing target coordinates is generated. As a method for generating approximated track, a track approximation method using a polynomial equation, a track approximation method using Fourier, and a track approximation method using neural network.

Hereinafter, the track approximation methods will be described.

At first, data distribution is expressed as a polynomial equation in the track approximation method using the polynomial equation. That is, given data is expressed as an approximated polynomial equation. The accuracy of a track can increase by using the higher degree of polynomial equation. The track approximation method using the polynomial equation can be expressed as Eq. 1.

y=a₀+a₁x+a₂x²+ . . . +aₙxⁿ Eq. 1

In Eq. 1, a denotes a coefficient, and x and y are variables for approximation. If a photographing time is used as a reference, x becomes a time, and y becomes the coordinate of a target area. Also, if a target area is used as a reference, x becomes a latitude, and y becomes a longitude.

An approximated equation can be obtained by a method of calculating the coefficient of the polynomial equation Eq. 1. The least square method is used to calculate the coefficient.

In the track approximation method using Fourier series, the coefficient of each terminal can be calculated using the least square method like the track approximation method using the polynomial equation. It can be expressed as Eq. 2 where y denotes a target function.

y=a₀z₀+a₁z₁+a₂z₂+ . . . +aₘzₘ Eq. 2

In Eq. 2, a denotes a coefficient and z is function for expressing y. That is, z is a sine function or a cosine function. The z function needs a variable x. The definitions of x and y are identical to those in Eq. 1.

The track approximation method using neural network can be expressed as Eq. 3.

y=Σνᵢψ^{s}(wᵢx+βᵢ)+α Eq. 3

In Eq. 3, ν and w denote weight, β and α denote bias. The definitions of x and y are identical to those in Eq. 1. A net value is calculated by multiplying each component of input with weight, and the output varies according to the net value and a function ψ^{s}(z). In general, the function ψ^{s}(z) can be expressed as Eq. 4.

$$\begin{matrix}{ψ}^{s} ( z ) = \{ \begin{matrix}0 , & z < - 0.5 \\ z + 0.5 , & - 0.5 \leq z \leq 0.5 \\ 1 , & z > 0.5\end{matrix} \} \approx ψ ( z ) \\ = \frac{1}{1 + {e}^{- λ z}} , λ = 10\end{matrix} \qquad Eq . 4$$

The track is approximated using the selected approximation algorithm and the photographing track is generated. After the photographing track is generated, the attitude angle is calculated using the location information of a satellite. Herein, the attitude angle can be calculated by calculating a vector between two points, the current location of a satellite and a target location.

Finally, the mission plan of a satellite is made based on the calculated attitude information and the mission plan is applied to control the attitude of a satellite.

As described above, the photographing track of a satellite is approximated based on information about a target area, and a pointing angle of a satellite is quickly calculated based on the approximated photographing track, thereby making a mission plan of a satellite using the calculated pointing angle. The satellite attitude control method using track approximation according to the present embodiment generate a target track to prevent abrupt attitude variation, prevents vibrations when a photographing mission is performed, and helps to make an operating plan of a satellite quickly and accurately. The satellite attitude control method using track approximation according to the present embodiment makes a satellite control system to quickly and efficiently generate a target track when the satellite is suddenly required to perform a photograph mission. Also, the satellite attitude control method using the track approximation according to the present embodiment makes the satellite to perform various missions.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 2006-0094396, filed in the Korean Intellectual Property Office on Sep. 27, 2006, the entire contents of which is incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A method for controlling an attitude of a satellite using target track approximation, comprising the steps of:
a) receiving coordinate information of at least one of target areas;
b) generating a target track by approximating a track of a satellite based on the received coordinate information; and
c) detecting a location of the satellite on a current track, calculating an attitude angle of the satellite for the target track using the location of the satellite and the location of the target area, and applying the calculated attitude angle of the satellite to control the attitude of the satellite.

2. The method of claim 2, further comprising the step of: d) making a satellite mission plan based on the calculated attitude angle of the satellite.

3. The method of claim 2, wherein in the step b), the target track passing all of the target areas is generated selectively using one of a target approximation method using a polynomial equation, a target approximation method using a Fourier series, and a target approximation method using a neuron network.

4. The method of claim 3, wherein the coordinate information of the target area includes a coordinate of a target area and a location of a satellite.

5. The method of claim 1, wherein in the step c), an attitude angle is calculated by obtaining a vector between the current location of a satellite and the target area if the current location and the target area are provided.
